(19) United States
(12) Patent Application Publication
(10) Pub. No.: US 2009/0139672 A1
(43) Pub. Date: Jun. 4, 2009

(54) CREPING AND CUTTING PROCEDURE AND EQUIPMENT

(76) Inventors: Jose Joaquin AMONARRIZ, Tolosa (ES); Jose Miguel ECHEBERRIA, Tolosa (ES)

Correspondence Address: LUCAS & MERCANTI, LLP, 475 PARK AVENUE SOUTH, 15TH FLOOR, NEW YORK, NY, 10016, US

(21) Appl. No.: 12/277,789

(22) Filed: Nov. 25, 2008

Related U.S. Application Data
(63) Continuation-in-part of application No. PCT/ES2007/000271, filed on May 9, 2007.

(30) Foreign Application Priority Data
May 25, 2006 (ES) 200601372

(51) Int. Cl. B31F 1/12; D21F 7/00

(52) U.S. Cl. 162/111; 162/280

(57) ABSTRACT

Creping and cutting procedure and equipment, for paper manufacture which consists of a creping doctor (1) carrying a blade (2) which carries out the creping; a corbel (12) which can pivot on a pivot shaft (5) in the geometrical centre of which the creping blade (2) works; primary means of actuation (3) which through the corbel (12) cause the rotation of the creping doctor (1) on a pivot shaft (4); and secondary means of actuation of variation of angle (6) which act on the corbel (12) and cause its rotation on a pivot shaft (5); in such a way that it is possible, with only two doctors (1), (7) to carry out the manoeuvres of creping, blade changing, cutting and cleaning.

### CROSS REFERENCE TO RELATED APPLICATIONS

This is a Continuation-in-part of International Patent Application No. PCT/ES2007/000271, filed May 9, 2007, which claimed the priority of Spanish Patent Application No. P2006/01372 filed May 25, 2006, the priority of both Applications is claimed and both Applications are incorporated herein by reference.

### FIELD OF THE INVENTION

This Invention refers to a procedure and facility for creping and cutting of a continuous band of paper which moves on a drying cylinder, as well as for cleaning of said drying cylinder, on machines for paper manufacturing.

### BACKGROUND OF INVENTION

Machines for paper manufacturing have progressed technologically bringing about an increase in speed of manufacturing and in the widths of the paper band manufactured. Currently, paper manufacturing machines, mainly of crepe paper, manufacture of speeds around 2000 m/min., and with paper band widths of up to 8 meters.

On said machines it is necessary that an essential element for connect and rapid execution of the paper, as in the facility of creping equipment (doctors), should have elements that are precise, durable and reliable, which adapt the creping blade or element to the surface of the cylinder, that said blade can be substituted, when worn, rapidly, without interruption of the paper band, and allows cutting and creping of said band, and which also allows changing of the angle of application of the blade on the roller automatically in order to modify the quality of the creping and cut the band.

In the current state of the technique, there are mainly two known types of facility and procedures:

a) In machines which do not allow the installation of three doctors, the procedure is as follows:
1. With the creping and cleaning doctors supported on the drying cylinder turning at the working speed, the Pick Up is closed, taking the paper band through the drying cylinder until said paper band reaches the creping blade. The creping blade unsticks the paper band from the drying cylinder, causing, upon unsticking, wrinkling in the paper band called “creping”. This creping can be controlled in various parameters (amplitude, percentage, etc.) through the use of an angle of application of the creping blade. Once the paper band is unstuck and creped, it is rolled on the roller (Pope).
2. When the creping blade, due to its constant friction against the drying cylinder, becomes blunt due to wearing of the edge, it must be changed. In order to do this, it is necessary to remove the creping blade, separating it from the drying cylinder with the action of the pneumatic cylinders on the creping doctor and extracting the creping blade and substituting it with a new one.

At the moment the creping blade is separated, the paper band continues to adhere to the drying cylinder until it is again unstuck by the cleaning blade which is applied with a high angle of application which does not allow creping, but only removes the paper band.

To again apply the creping blade to the roller, and given that the angle of application of the creping blade used to crepe does not allow cutting of the paper band so that the creping blade reaches the drying cylinder (5) entirely, it is necessary to open the Pick Up, thus directing the paper band to the recovery circuit and leaving the drying cylinder without a blade. The creping doctor is applied again and the cycle starts again.

Considerable time is taken in this operation of blade changing, resulting in a significant loss in production.

b) In machines which allow the installation of three doctors, the procedure is as follows:
1. With the creping and cleaning doctors supported on the drying cylinder turning at the working speed, and the cutting doctor removed, the Pick Up is closed, taking the paper band through the drying cylinder until said paper band reaches the creping blade. The creping blade unsticks the paper band from the drying cylinder, causing, upon unsticking, wrinkling in the paper band called “creping”. This creping can be controlled in various parameters (amplitude, percentage, etc.) through the use of an angle of application of the creping blade. Once the paper band is unstuck and creped, it is rolled on the roller (Pope roller).
2. When the creping blade, due to its constant friction against the drying cylinder, becomes blunt due to wearing of the edge, it must be changed. In order to do this, it is necessary to divert the paper band toward the recovery circuit, which is done by applying the cutting doctor with the appropriate angle of application to produce a fast and clean cut of said paper band.
3. The creping doctor is removed and the worn creping blade is extracted and is substituted with a new one.
4. The creping doctor is applied again with the appropriate load and angle.
5. The cutting doctor is removed and the facility continues in production.

### SUMMARY OF THE INVENTION

The new facility which is the object of the invention operates in such a way that with only two doctors, the manoeuvres of creping, blade changing, cutting and cleaning can be done, all without the need to open the Pick Up, with the same efficiency and safety and in the same time as with an installation with three doctors.

The execution of the manoeuvre is totally automatic and allows the modification of the creping and cutting angles.

The procedure is as follows:

a) The creping and cleaning doctors are applied with the drying cylinder turning at the working speed and with the creping angle on the creping blade and with the cleaning angle on the cleaning blade.

b) The paper sheet or band reaches the creping blade which unsticks and crepes said sheet.

c) When the blade becomes blunt because of its constant friction with the drying cylinder, it should be replaced with a new creping blade. To do this, the creping blade should be disabled by raising the doctor blade by means of the corresponding operating mechanism. The sheet is removed by the cleaning blade and then the worn creping blade is replaced and a new blade set in place. When the doctor blade arrives at the position where the blade has been changed, the operating mechanism varies the angle and automatically operates on the support plates, changing the creping blade angle of application for the operating angle for cutting the sheet of paper. Once the creping blade has been replaced, the creping doctor blade is applied again, but with the corresponding angle of application for the cutting operation. Once the sheet of paper has been cut, the angle of application is modified, passing from the cutting process to the creping process thanks to the action of the angle variation components.

A paper web creping and cutting facility is described, which travels on a drying cylinder inside a paper-making machine, consisting of a structure (b) that supports a creping doctor blade bearing a creping blade that performs the creping process, with the invention being characterized by the fact that it comprises:

a) a support plate that can rotate on the structure (b) around a primary rotating collar at the geometric axle around which the creping blade operates, with the doctor being able to rotate on the support plate around a second rotating collar;

b) operating mechanism supported by the support plate which is designed to make the doctor blade rotate between the position in which the creping blade is applied to the drying cylinder and a position for changing the blade in which the creping blade is separated from the drying cylinder;

c) a second operating mechanism with angle variation which is supported by a structure (b) and runs on the support plate, being designed in such a way as to make the support plate rotate around the primary rotating collar in order to vary the angle of application of the creping blade between a cutting angle for the paper web and a creping angle for the paper web.

The advantages to be derived from using the process and the facility forming the object of the invention are clear:

a) modification of the angle of application for the blade by means of remote control, with it being possible to perform this operation equally well with the paper-making machine running or at a standstill, without interrupting production.

b) possibility of changing the angle, so as to be able to work with a single doctor blade being used for cutting and creping.

c) use a crepe paper-making machines with two doctor blades (creping and cleaning).

d) in the machines which allow the use of only two doctors, the need to open the Pick Up for the manoeuvre of creping blade substitution is eliminated, with the resulting savings in working time and paper recycling.

To better understand the object of this invention, a preferable way of its embodiment is shown on the drawings, subject to minor changes which do not fundamentally change it.

### BRIEF DESCRIPTION OF THE DRAWINGS

FIG. 1 illustrates the creping and cleaning doctors;

FIG. 1a illustrates a front view;

FIG. 1b illustrates a front view with paper;

FIG. 2 illustrates the creping and cleaning doctors with new creping blades;

FIG. 3 illustrates a change of angle;

FIG. 4 illustrates another angle; and

FIG. 5 illustrates a perspective view.

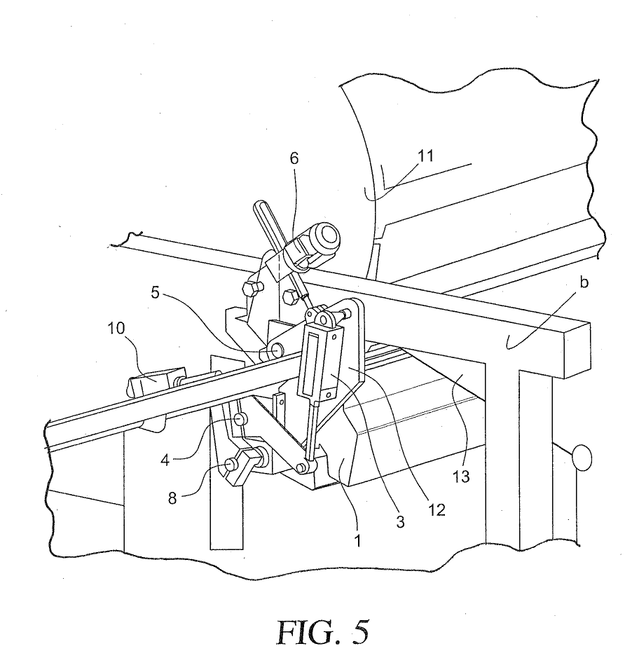

### DETAILED DESCRIPTION OF THE INVENTION

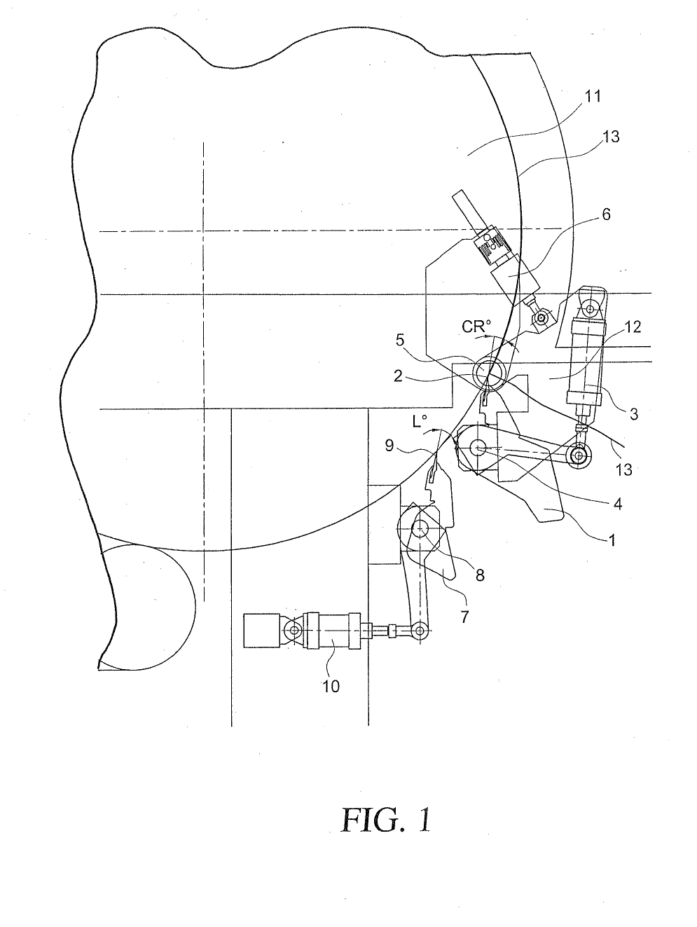

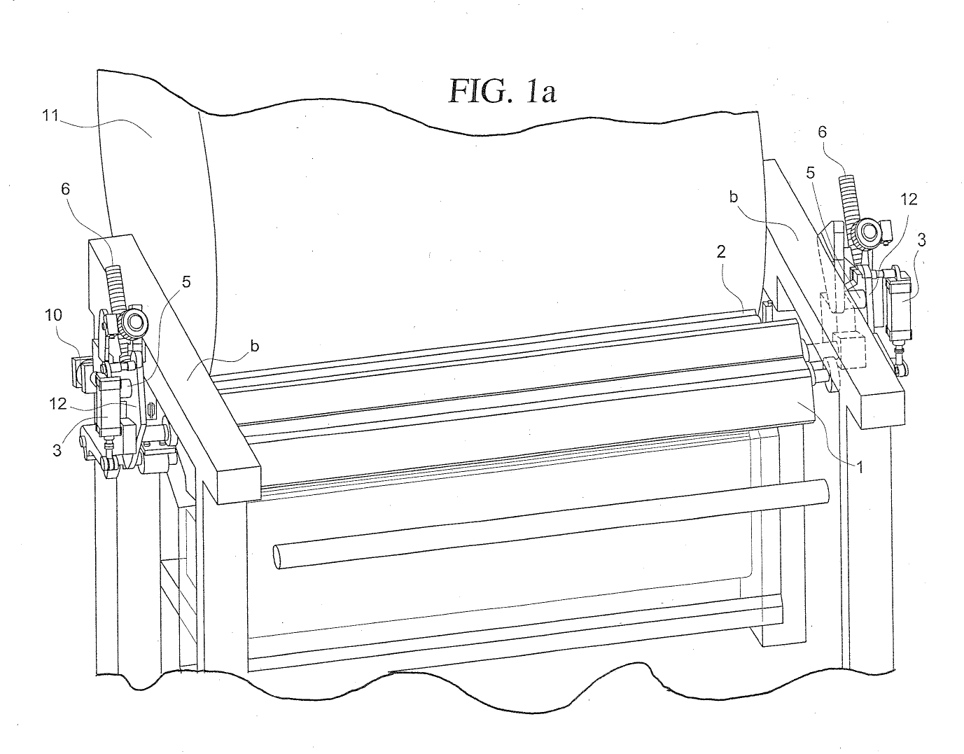

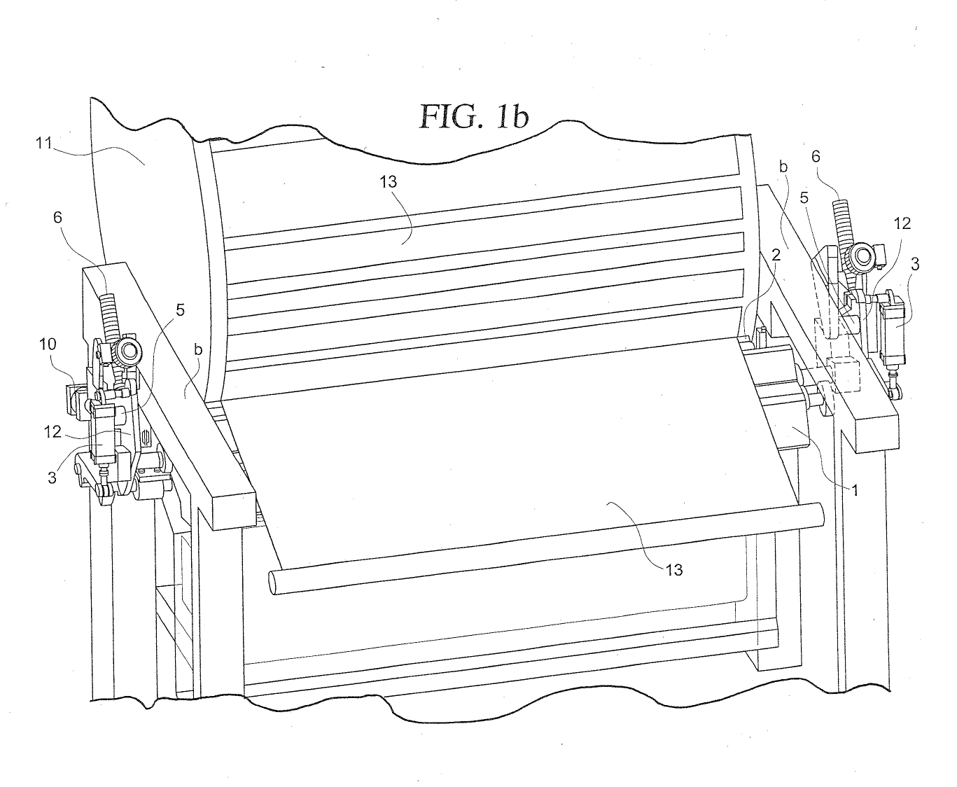

FIG. 1 is an exploded view in the application phase of the creping (1) and cleaning (8) doctors, with the drying cylinder (11) turning at working speed, with the creping angle (CR°) on the creping blade (2) and with the cleaning angle (L°) on the cleaning blade (9).

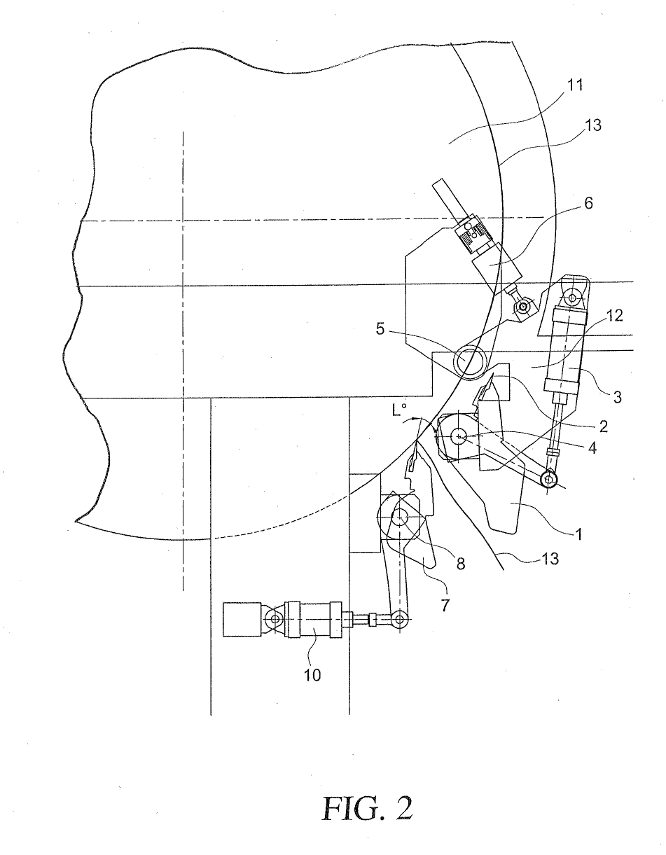

FIG. 2 is an exploded view similar to the foregoing one, in the application phase of substitution of the creping blade (2) with a new one.

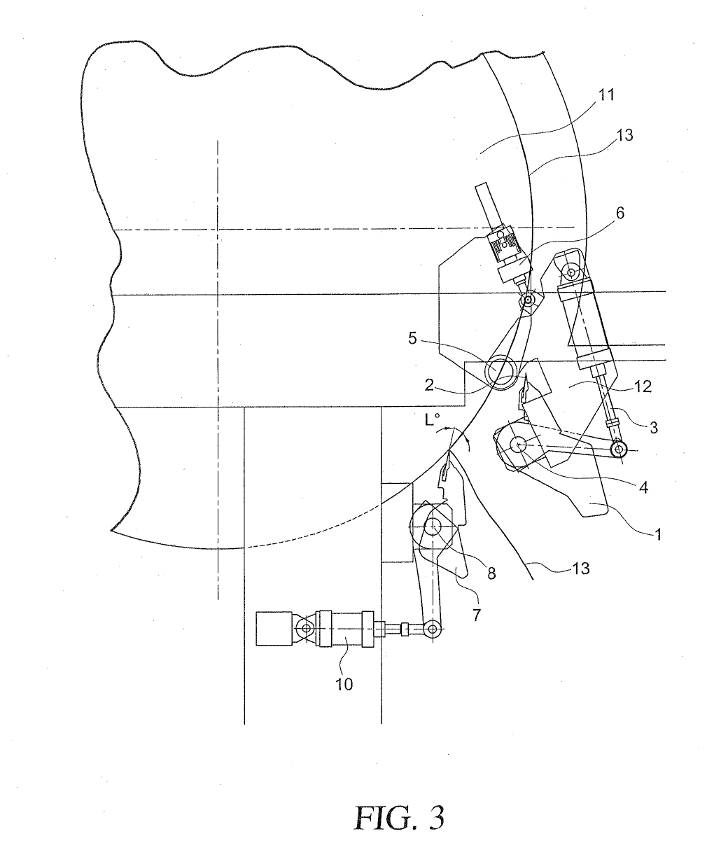

FIG. 3 is an exploded view similar to the foregoing ones, with the action of the means for actuating of angle variation (6), changing the angle (CR°) of application of the blade (2) relevant to creping by the angle (C°) of application of the blade (2) relevant to the cutting.

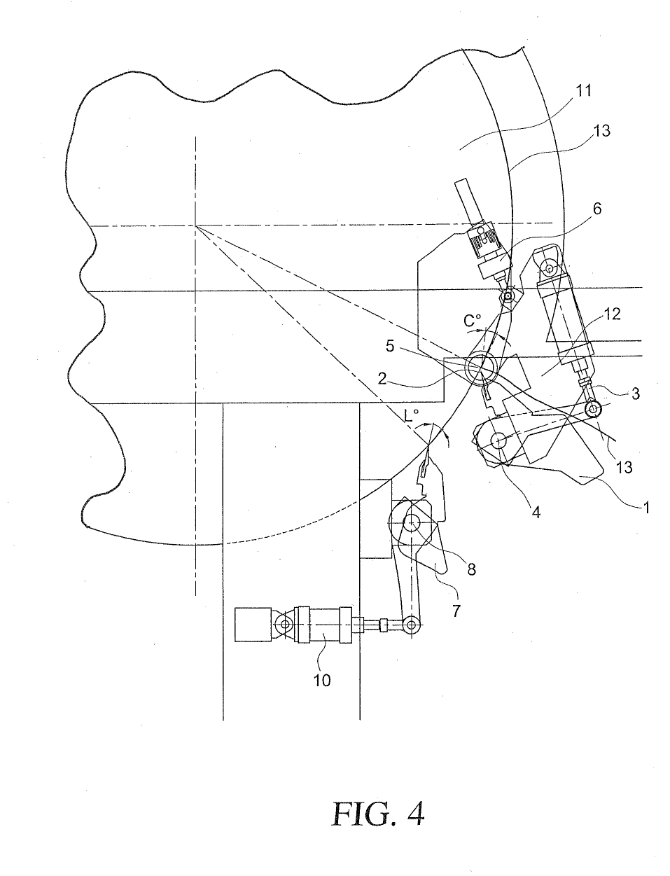

FIG. 4 is an exploded view similar to the foregoing ones, again applying the creping doctor (1) but with the angle of application (C°) relevant to the cutting operation.

Described as follows is an example of practical, non-limiting embodiment of this invention.

The object of the invention is a new creping and cutting procedure and facility equipped with the components and positioning necessary to carry out the manoeuvres of cutting and creping using a single doctor (1), automatically modifying the change of its angle: from creping angle (CR°) to cutting angle (C°) and vice versa.

In accordance with the invention, and according to the embodiment shown in FIGS. 1 to 4, the facility basically includes the following elements or parts making it up:

1. Creping element (creping doctor).

2. Blade which carries out the creping (creping blade).

3. Means for actuation which act on the creping doctor (1), applying the creping blade (2) to the drying cylinder (11) or removing it.

4. Pivot shaft of the creping doctor (1).

5. Pivot shaft of the corbel (12) which pulls the creping doctor with it (1) and means of actuation (3) of the blade (2) for the changing of creping angle (CR°) to cutting (C°) and vice versa.

6. Means of actuation for the variation of creping angle (CR°) to cutting (C°) and vice versa.

7. Cleaning element (cleaning doctor).

8. Pivot point of the cleaning doctor.

9. Blade which carries out the cleaning (cleaning blade).

10. Means of actuation for the application and raising of the cleaning doctor (7).

11. Drying cylinder.

12. Corbel.

13. Paper sheet (Paper band).

Particularly, and according to the embodiment shown, the means of actuation (3), (6), (10) are pneumatic cylinders, although they can alternatively be mechanical spindles, hydraulic cylinders or other systems of liner or angular actuation, without essentially altering the invention.

In the procedure of creping and cutting, according to the invention—see FIG. 1—:

a) The creping (1) and cleaning (8) doctors are applied with the drying cylinder (11) turning at the working speed and with the creping angle (CR°) on the creping blade (2) and with the cleaning angle (L°) on the cleaning blade (9).

The sheet (13) or paper band reaches the creping blade (2) which unsticks and crepes said sheet—see FIG. 1—.

b) When the blade (2) becomes blunt due to constant friction with the drying cylinder (11) it is necessary to substitute it with a new creping blade (2). In order to do this, the creping blade (2) is separated, raising the creping doctor (1) through actuation of the pneumatic cylinders (3). The blade is unstuck by the cleaning blade (9) and the used creping blade (2) is substituted and a new one is put in place—see FIG. 2—. When the creping doctor (1) reaches the blade-changing position the means of actuation of angle (6) variation act automatically on the corbels (12), changing the angle of application (CR°) of the creping blade (2) to the angle of actuation (C°) for the execution of the cutting of the sheet (13)—see FIG. 3—. When the creping blade is substituted (2) the creping doctor (1) is again applied, but with the angle of application relevant to the cutting operation (C°)—see FIG. 4—.

When the sheet (13) is cut, the angle of application is again modified, going from cutting (C°) to creping (CR°) through the use of the means of actuation (6), which produce the variation of angle.

1. Creping and cutting installation for a continuous band of paper (13) which travels on a drying cylinder (11) inside a paper-making machine, consisting of a structure (b) that supports a creping doctor blade (1) bearing a creping blade (2) that performs the creping process, with the invention being characterized by the fact that it comprises:
a) a support plate (12) that can rotate on the structure (b) around a primary rotating collar (15) at the geometric axle which the creping blade (2) rotates around, with the creping doctor blade (1) being able to rotate on the support plate (12) around a second rotating collar (4);
b) operating mechanism (3) supported by the support plate (12) which is designed to make the doctor blade (1) rotate between the position in which the creping blade (2) is applied to the drying cylinder (11) and a position for changing the blade in which the creping blade (2) is separated from the drying cylinder (11);
c) a second operating mechanism with angle variation (6) which is supported by a structure (b) and which operates on the support plate (12), being designed to make the support plate (12) rotate around the primary rotating collar (5) in order to vary the angle of application of the creping blade (2) between a cutting angle (C°) for the paper web and a creping angle (CR°) for the paper web (13).

2. Creping and cutting procedure for a continuous band of paper, which travels on a drying cylinder inside a paper-making machine using an installation in accordance with claim 1 wherein:
a) when the creping blade (2) becomes blunt, the creping blade (2) is removed from the drying cylinder (11) by making the doctor blade (1) rotate towards the primary operating machanism (3);
b) when the creping doctor blade (11) arrives at the position where the blade (2) has been changed, the secondary operating mechanism (6) which operates on the support plate (12) is automatically activated, with the creping angle (CR°) being replaced by the cutting angle (C°);
c) once the creping blade (2) has been replaced, the creping doctor blade (1) rotates to the position in which the creping blade (2) is once again applied to the drying cylinder (11) with the cutting angle (C°), for cutting the paper web (13);
d) once the sheet of paper or the paper web (13) has been cut, the secondary operating mechanism (6) which operates on the support plate (12) is activated again, with the cutting angle (C°) being replaced by the creping angle (CR°).

3. Procedure, according to claim 2, wherein the modification of the angle of application for the creping blade (2) on the drying cylinder (11) by means of the second operating mechanism (6) is done with the paper-making machine either at a standstill or with the machine running, without interrupting production.
